(19) United States
(12) Patent Application Publication
(10) Pub. No.: US 2024/0400901 A1
(43) Pub. Date: Dec. 5, 2024

(54) METHOD FOR THE PREPARATION OF A THERMOPLASTIC LIQUID CRYSTALLINE POLYMER

(71) Applicant: TECHNISCHE UNIVERSITEIT EINDHOVEN, Eindhoven (NL)

(72) Inventors: Sean Jean Daniël LUGGER, Eindhoven (NL); Dirk Jan MULDER, Eindhoven (NL); Albertus Petrus Hendrikus Johannes SCHENNING, Eindhoven (NL)

(21) Appl. No.: 18/699,142

(22) PCT Filed: Oct. 7, 2022
(86) PCT No.: PCT/NL2022/050569

§ 371 Date: Apr. 5, 2024

(30) Foreign Application Priority Data
Oct. 7, 2021 (NL) 2029336

(51) Int. Cl. C09K 19/38

(52) U.S. Cl. CPC C09K 19/3809; C09K 2211/1425

(57) ABSTRACT

The present invention relates to a method for the preparation of a thermoplastic liquid crystalline polymers. The present invention also relates to segmented copolymers containing thiourethane, amide, or linear bismaleimide hard segments and liquid crystal soft blocks and to thermoplastic liquid crystal elastomer (LCE) actuators containing the same.

The present invention relates to a method for the preparation of a thermoplastic liquid crystalline polymers. The present invention also relates to segmented copolymers containing thiourethane, amide, or linear bismaleimide hard segments and liquid crystal soft blocks and to thermoplastic liquid crystal elastomer (LCE) actuators containing the same.

Stimuli-responsive LCEs are capable of performing fast, reversible actuation and have readily been applied as soft actuators in applications such as soft robotics, smart textiles, microfluidics, and artificial muscles. A macroscopic mechanical response arises from an ordered to less ordered state in the covalently cross-linked network thermosets. Hence, subjecting the responsive LCEs to an external stimulus such as heat results in a contraction along the orientated mesogens-based network's director field and expansion perpendicular to it, inducing macroscopic shape changes. After removing the stimulus, the initial molecular order is recovered, and the shape is restored due to the cross-linked network. A proven method to prepare aligned LCEs is by first mechanically stretching a partially cross-linked material to induce alignment, followed by fully photo-crosslinking the polymer locking in the desired molecular orientation of the mesogens. Although the currently available materials exhibit large deformations, have good mechanical properties, and are sufficiently stable, they cannot be reprocessed and recycled.

One strategy to overcome the limitations inherent to a permanent cross-linked polymer network is to use dynamic covalent bonds instead. Dynamic covalent networks have been reported demonstrating more versatile processability of the developed dynamic LCE network. Rearranging the molecular structure of these covalently exchangeable networks is facilitated by a chemical reaction often requiring a catalyst. While LCE actuators based on dynamic covalent networks are capable of welding and reprogramming, LCE actuators that are melt-processable with programmable molecular orientation render new possibilities to further develop these materials compatible with conventional processing methods using the polymer melt.

An alternative strategy to circumvent permanently cross-linked networks is by introducing supramolecular interactions as dynamic physical cross-links. Among the potential supramolecular interactions, hydrogen bonds have emerged as one of the most attractive interactions, and hydrogen-bonded liquid crystal (LC) polymers capable of reversible actuation have become an emerging research area. To date, however, supramolecular cross-linked LCE actuators have been prepared by multistep synthesis while simultaneous integrated stimuli-responsive, reprogrammable, and reprocessable properties have not been reported.

An object of the present invention is to provide a thermoplastic actuation element by using a stimuli-responsive thermoplastic liquid crystalline polymer.

The present invention is characterized by the appending set of claims. The object is achieved by thermoplastic LCE actuators that are based on segmented copolymers containing thiourethane (TU), amide, or linear bismaleimide hard segments and LC soft blocks.

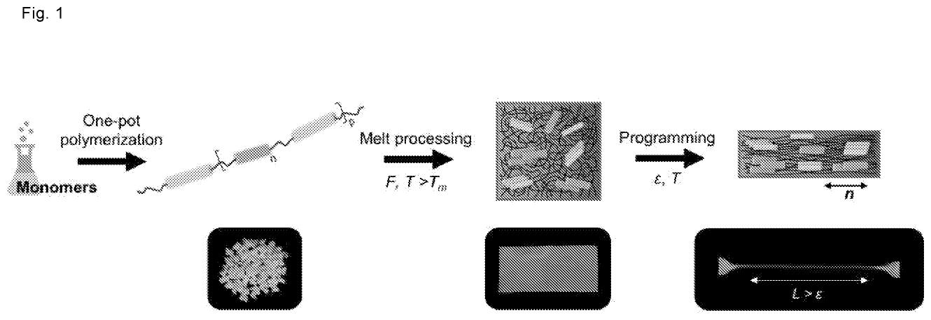

The present inventors found that TU segments contain hydrogen bonds that form a physically cross-linked network at room temperature, ensuring sufficient mechanical integrity and excellent mechanical properties. Whereas at higher temperatures, the thermoplastic behavior of the material is regained, allowing for the preparation of LCE actuators through melt-processing and thermal programming (FIG. 1). Thermoplastic LCEs having different lengths of the soft LC oligomer blocks have been synthesized in one step, from which we evaluated the effect of the block copolymer composition on structure, mechanical properties, and actuation performance. Through the straightforward incorporation of an azobenzene photoswitch, the actuator can be reversibly actuated in response to light in air and underwater. Additionally, the thermoplastic LCE material can be reprocessed as well as configured into another shape showing different stimuli-triggered deformation.

A thermoplastic actuation element is a melt processable polymer that changes its shape reversibly upon exposure to a certain stimulus (e.g. heat or light). The present invention includes a method of producing and processing this material and compositions to achieve the desired properties. The desired properties include the thermal-mechanical properties (e.g. elastic modulus and transition temperatures) of the polymer, (meso) phases and transition temperatures, to which stimulus the elastomer will respond (e.g. temperature or light), and to what extent the elastomer will change its shape or generate work (actuation strain and stress).

The present method of producing a liquid crystalline thermoplastic polymer involves sequential addition reactions, where a bifunctional mesogenic oligomer (i.e. short polymer with (meth)acrylate, thiol, alcohol, or amine end-groups) is prepared by reacting at least a liquid crystalline component, and a bifunctional thiol or amine component, and where subsequentially a segmented copolymer is prepared by reacting at least a bifunctional mesogenic oligomer, a bisacrylamide or bismaleimide or isocyanate, and a bifunctional thiol, alcohol or amine component.

The present invention thus relates to a method for the preparation of a thermoplastic liquid crystalline polymer, the method comprising the following steps:
a) reacting a di(meth)acrylic mesogenic monomer and a bifunctional thiol or amine component for preparing a mesogenic bifunctional polymer, and
b) reacting the mesogenic bifunctional polymer of a), a bisacrylamide, isocyanate or bismaleimide, and a bifunctional thiol, alcohol or amine component for preparing the thermoplastic liquid crystalline polymer.

The present invention thus relates to a segmented thermoplastic liquid crystalline polymer, which is produced by sequential addition reactions, where a mesogenic bifunctional polymer, represented by general formula (1) and later referred to as mesogenic segment, is prepared by reacting at least a liquid crystalline bisacrylate or bismethacrylate component (X), and a bifunctional thiol or amine component (L₁-Z₁), and where a copolymer, represented by general formula (2) and later referred to as hard segment, is prepared by reacting at least a mesogenic bifunctional polymer (1), a bisacrylamide, isocyanate or bismaleimide (Y), and a bifunctional thiol, alcohol or amine component (L₂-Z₂).

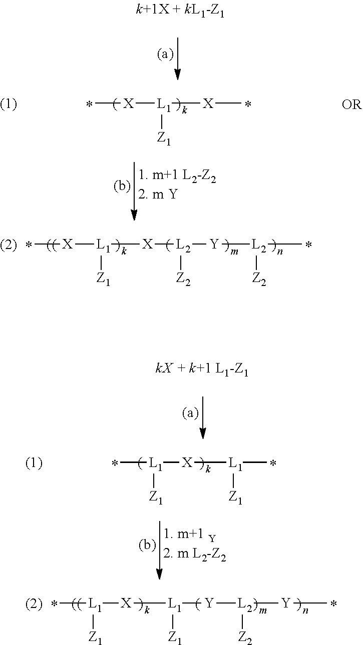

In an example the thermoplastic liquid crystalline polymer exhibits a T_{g} between −100° C. and Tm, and preferably below the isotropization temperature (Tᵢ) of the mesogenic segment.

In an example the thermoplastic liquid crystalline polymer exhibits a melting point (T_{m,LC}) of the mesogenic segment between T_{g} and Tₘ.

In an example the thermoplastic liquid crystalline polymer is light responsive when either an azobenzene derivative or another chromophore is used, either partly or fully, as the component represented by (X) in the mesogenic segment, or is added as additive to the elastomer.

In an example X is a mesogenic monomer containing at least two vinylic, two acrylic, or two methacrylic, or a combination of two of the aforementioned groups, wherein X is preferably chosen from the group of:

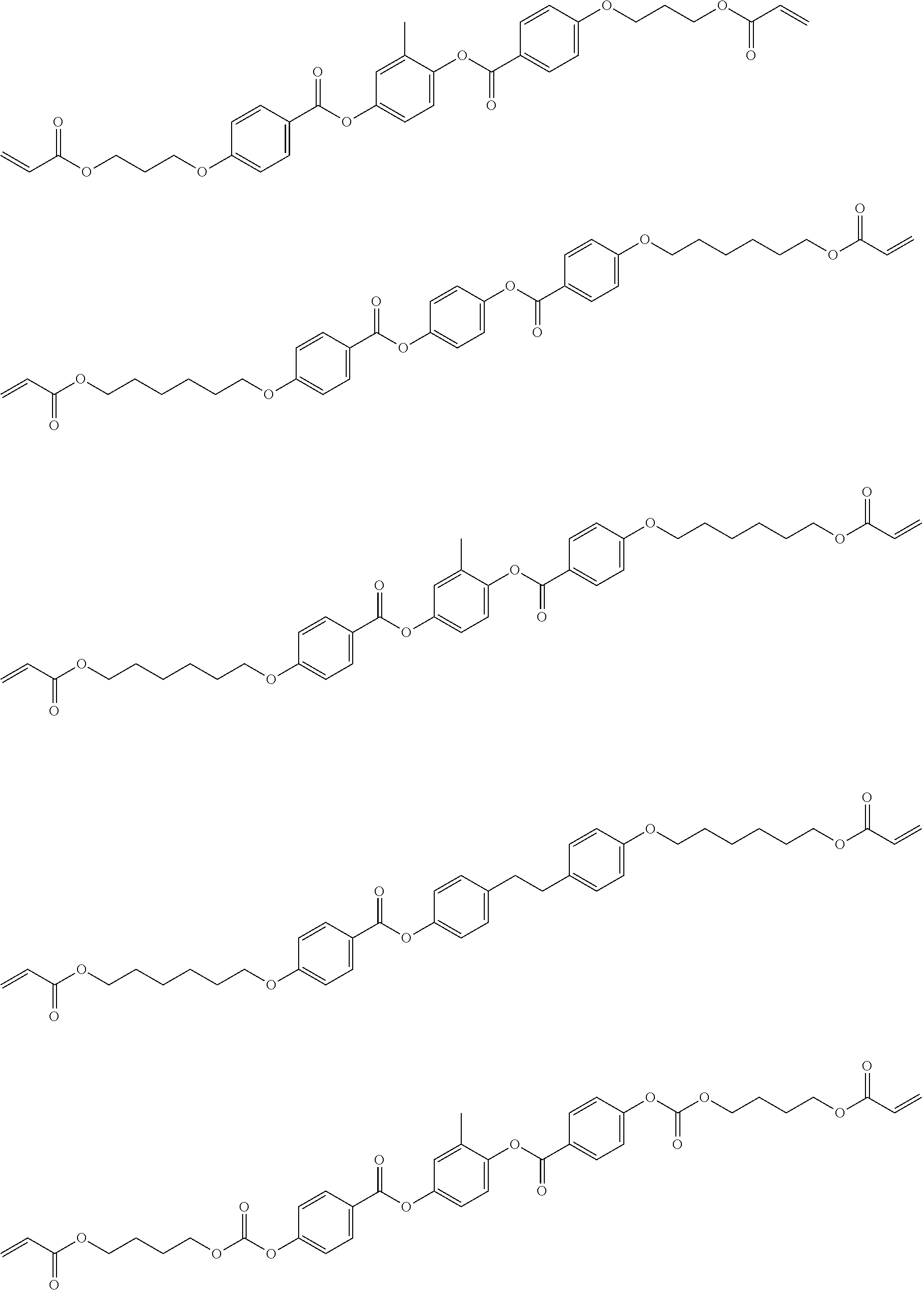

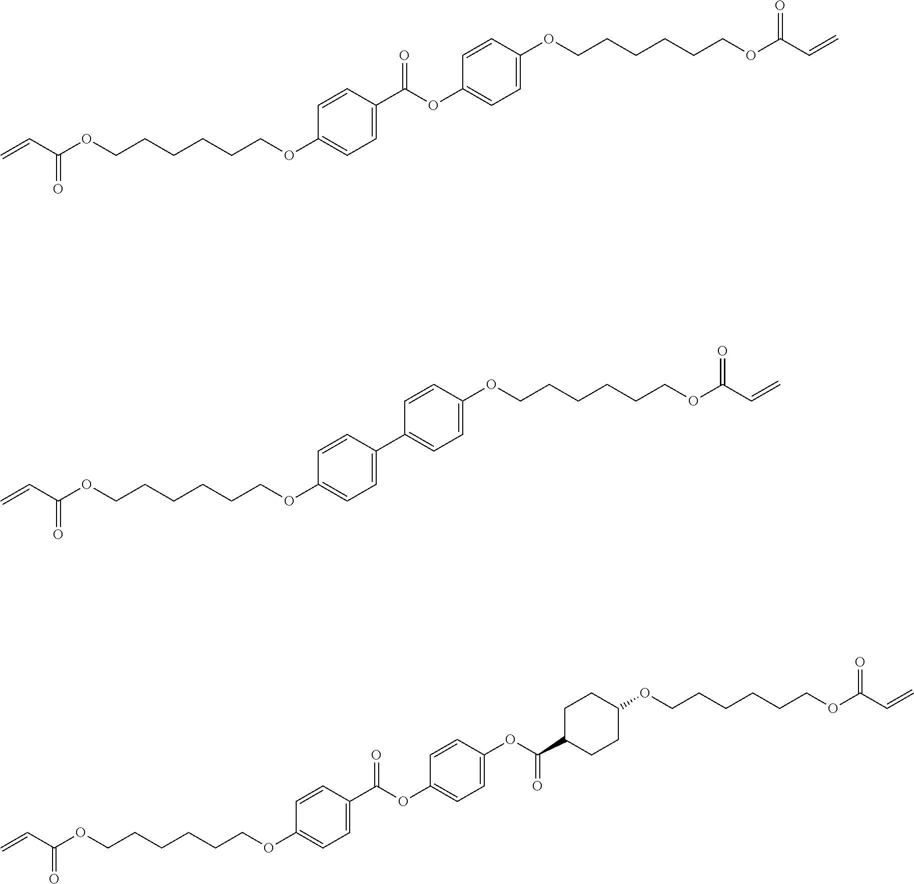

In an example L1 and L2 are linking monomers, and Z1 and Z2 are side group on linking monomers, respectively, wherein L1, L2, Z1 and Z2 are preferably chosen from the group of:

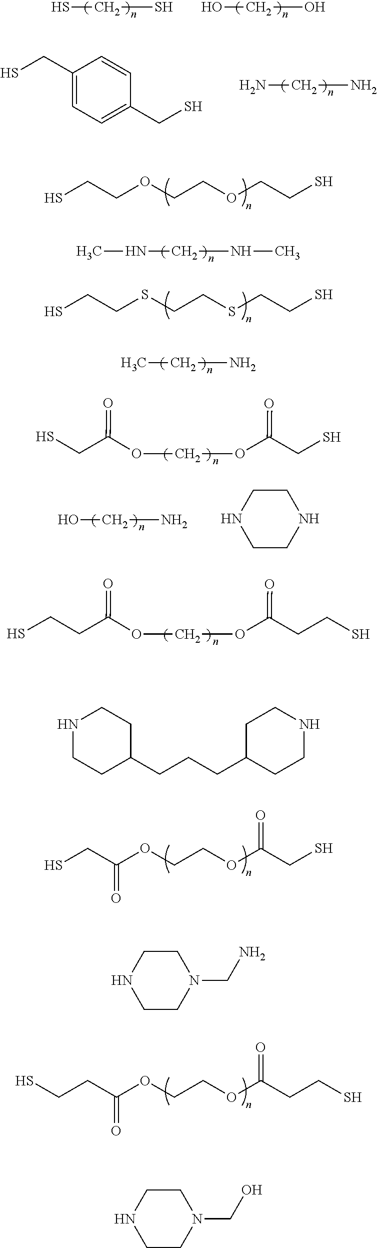

In an example Y is a monomer preferably chosen from the group of

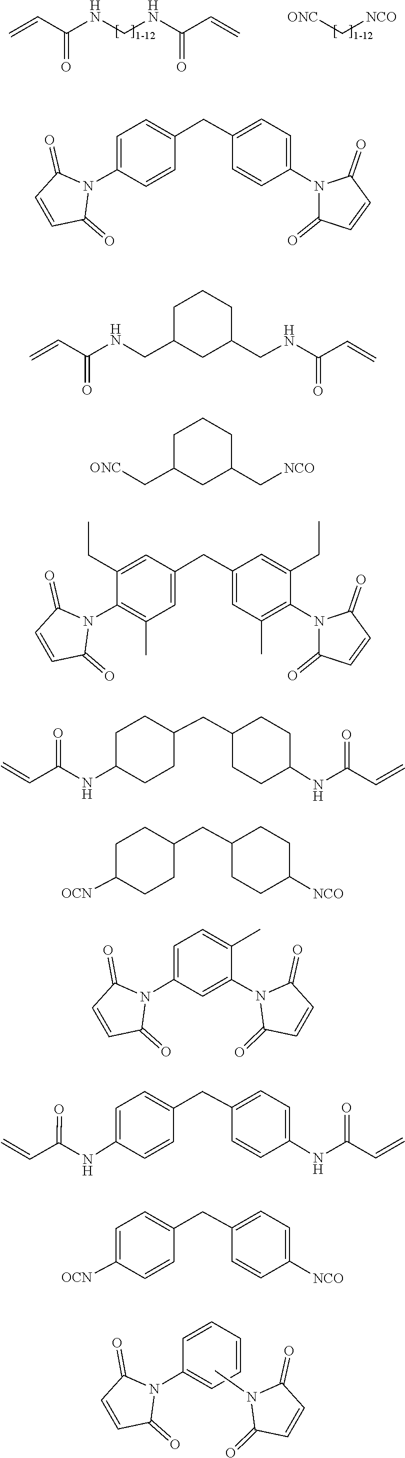

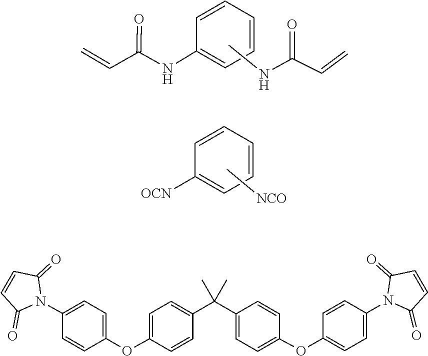

The present invention will now be discussed in more detail.

FIG. 1 shows the preparation of supramolecular cross-linked LCE actuators based on a thermoplastic PTU as melt-processable material.

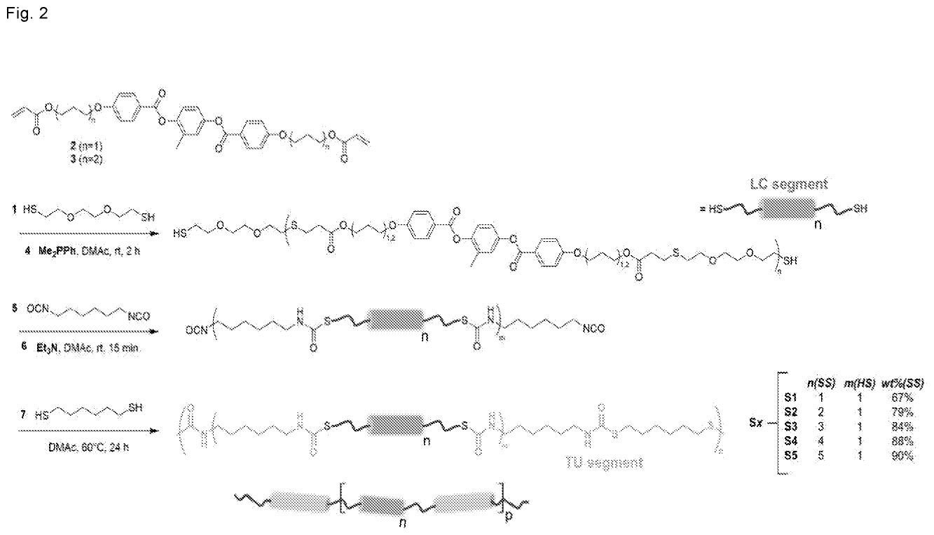

FIG. 2 shows the synthesis of segmented PTU LCEs S1-S5 using sequential addition reactions and the corresponding composition, Sx.

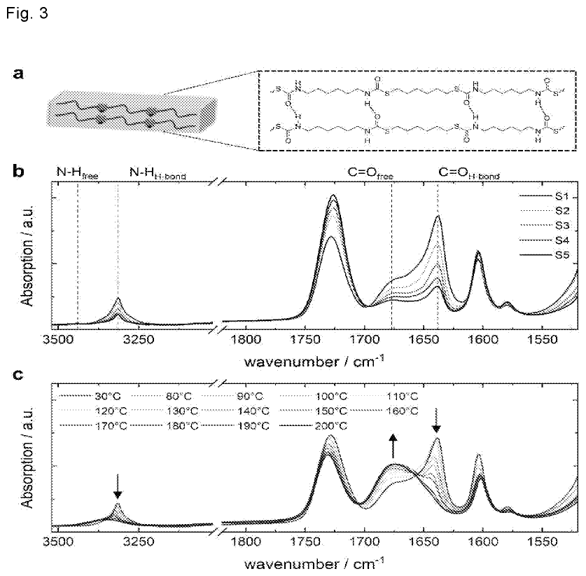

FIG. 3 a) shows the molecular representation of hydrogen-bonded TU segments in the segmented polythiourethane LCEs.

FIG. 3 b) shows the FTIR spectra of the PTU LCEs S1-S5 showing free and hydrogen-bonded TU amine and carbonyl stretching band regions as indicated by the dashed lines.

FIG. 3 c) shows the temperature-dependent FTIR spectra of compression-molded PTU LCE S1.

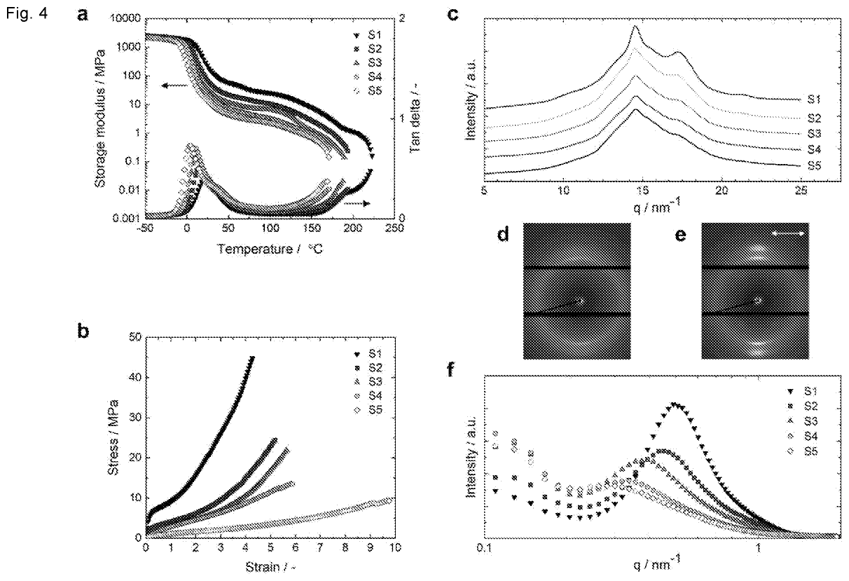

FIG. 4 a) shows the DMA storage modulus (E′) and loss tangent (tan δ) profiles as a function of temperature of the compression-molded PTUs S1-S5. \

FIG. 4 b) shows the stress-strain curves at room temperature of the compression-molded PTUs S1-S5.

FIG. 4 c) shows the 1D WAXS diffractograms of the aligned PTUs S1-S5.

FIG. 4 d) shows the 2D WAXS diffractograms of PTU S1 before programming.

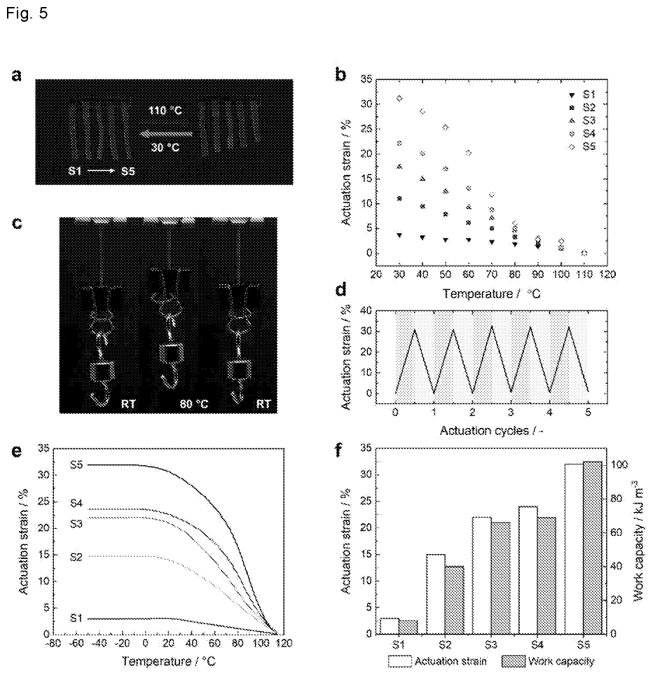

FIG. 4 e) shows the 2D WAXS diffractograms of PTU S1 after programming FIG. 5 a) shows images of the LCE actuators S1-S5 (from left to right) at 30° C. and 110° C.

FIG. 5 b) shows the corresponding actuation strain as a function of temperature.

FIG. 5 c) shows images of PTU LCE S5 lifting an additional weight (5 g) when heated to 80° C.

FIG. 5 d) shows actuation strain upon cycling the PTU LCE S5 with a load (5 g) between room temperature and 80° C.

FIG. 5 e) shows thermal actuation of the aligned LCEs S1-S5 under constant bias stress (250 kPa).

FIG. 5 f) shows maximum actuation strain ratio and corresponding actuation work capacity for each LCE.

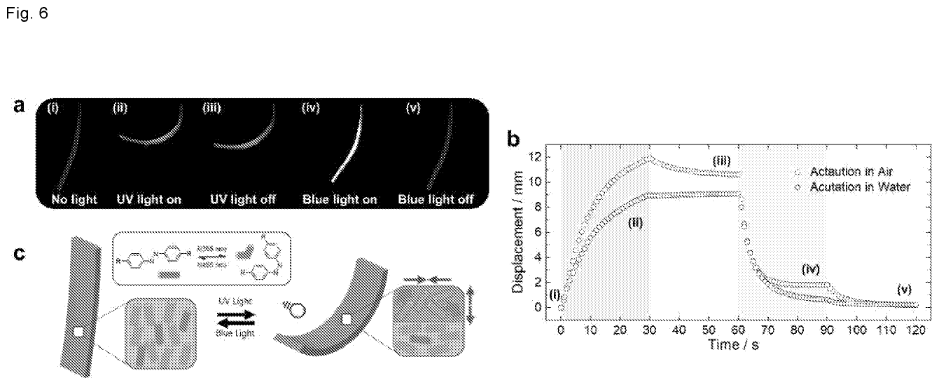

FIG. 6 a) shows images of the actuation in air.

FIG. 6 b) shows tip displacement of the actuator as a function of time in both air and water during UV (violet) and blue (blue) light illumination.

FIG. 6 c) shows light-induced trans-cis isomerization of an azobenzene derivative.

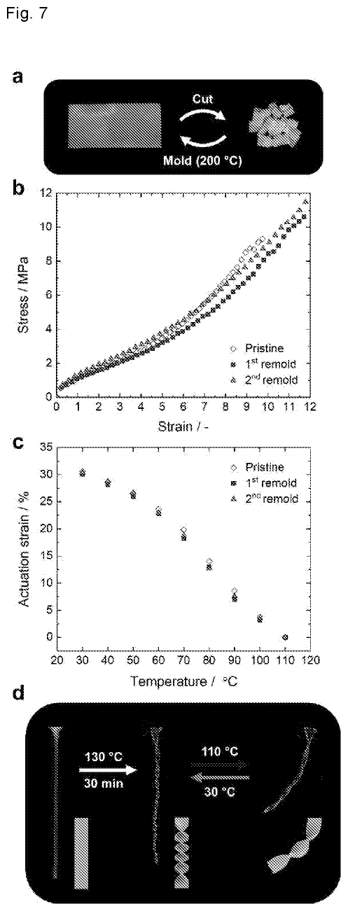

FIG. 7 a) shows reprocessing cycle of PTU LCE S5.

FIG. 7 b) shows stress-strain curves at room temperature.

FIG. 7 c) shows the actuation strain as a function of temperature of pristine and remolded samples.

FIG. 7 d) shows reprogramming of aligned LCE S5 into a twisted ribbon and the corresponding actuation in response temperature.

To create supramolecular cross-linked thermoplastic LCEs, main-chain LC polymers were prepared using sequential thiol-acrylate and thiol-isocyanate addition reactions. A one-pot method was used to synthesize segmented PTU materials in which the LC soft segment length was systematically changed (FIG. 2). First, the thiol functionalized LC oligomer soft segment was synthesized by a nucleophilic thiol-Michael addition reaction between a small excess of dithiol (1) and an equimolar mixture of diacrylate mesogens (2 and 3) in the presence of a phosphine catalyst (4). Subsequently, in the same flask, a prepolymer was prepared by a base-catalyzed thiol-isocyanate addition reaction between the synthesized thiol-terminated oligomers and an aliphatic diisocyanate (5) mediated by an amine catalyst (6). In the final stage, the prepolymer was reacted with a difunctional thiol (7) to yield a linear LC PTU. In our experiments, the nomenclature of the PTU LCEs, Sx, denotes the calculated mean length of the soft LC segment (Sx, i.e., number of mesogens). The mean length of the LC segment chains was controlled from one to five repeating (S1-S5) units by the stoichiometric ratio of dithiols and reactive mesogens as obtained by theoretical calculation using Carothers' equation (Table S1). In contrast, the hard TU segment length was maintained constant (Mn,theo=487 g mol-1). Moreover, as the soft segment's length and content increase from one to five mesogens per segment, the TU segment content decreases from 31 to 10 wt %, respectively (Table S2). A series of white polymers with near-quantitative yields was obtained by precipitation of the reaction mixture into cold diethyl ether. It should be noted that two different dithiols (1 and 7) have been used for the formation of thermoplastic PTU LCEs since the incorporation of only one dithiol in both segments drastically decreased the degree of microphase-separation and properties of the material.

For all synthesized materials, the formation of polymers was confirmed by Fourier-transform infrared spectroscopy (FTIR), as indicated by the disappearance of thiol and isocyanate stretching bands at 2560 and 2270 cm-1, respectively. Additionally, characteristic amine and carbonyl vibrations were observed for all materials that are indicative of the successful formation of TU moieties. The observed number-average molecular weight (85000-157000 g mol-1) and relatively low polydispersity (2.0-2.7) of all materials from gel permeation chromatography (GPC) indicate the successful synthesis of polythiourethanes (Table S3).

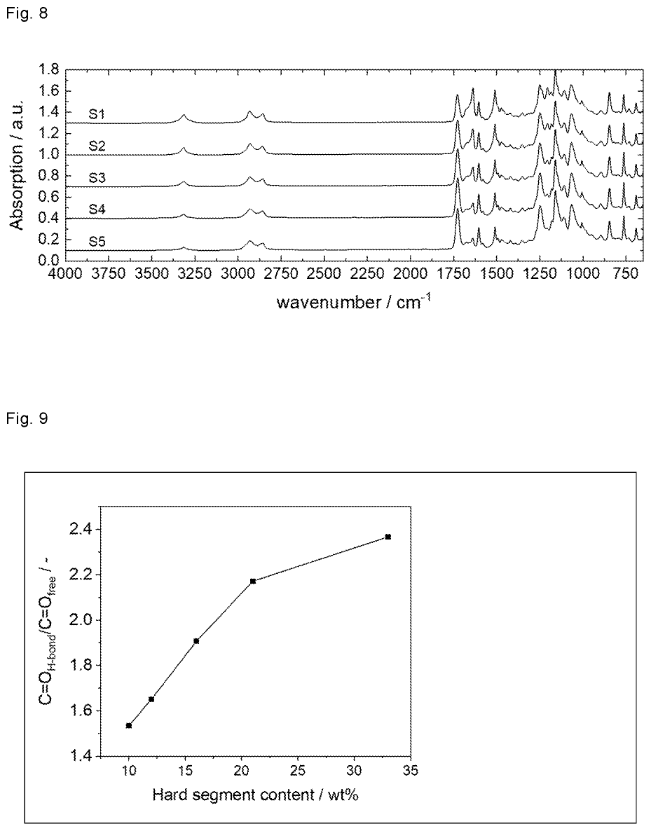

The hydrogen bonding properties of the PTU LCEs were investigated by FTIR spectroscopy (FIG. 3; FIG. 8). The extent of hydrogen bonding within the TU segment was assigned to the absorption in the TU amine (3200-3400 cm-1) and carbonyl (1600-1800 cm-1) regions (FIG. 3b). Hydrogen-bonded (N—H H-bond) and free (N—H free) TU amine stretching bands were observed at 3315 and 3440 cm-1, respectively. The N—H H-bond stretching band appeared as sharp vibration for all PTU LCEs, while the N—H free could be observed weakly, indicating the formation of well-organized hydrogen-bonded TU segments. The ordered hydrogen-bonded (C═OH— bond) and free (C-Ofree) carbonyl stretching bands of the TU segments were observed at 1638 and 1677 cm-1, respectively. As expected, the absorption of the hydrogen-bonded TU amine and carbonyl stretching vibrations increased consistently with increasing TU segment content from LCEs S5 to S1. On the contrary, the absorption of free TU amine decreased with increasing TU segment content. The absorption band of hydrogen-bonded carbonyl groups is larger than free carbonyl groups, and the corresponding ratio (C═O H-bond/C—O free) increases with the TU segment content (FIG. 9). These results suggest that the extent of hydrogen bonding increases at higher TU segment concentrations and indicates a more substantial degree of microphase separation between the LC and TU segments for shorter LC segment lengths. That said, the prepared samples exhibit strong hydrogen bonding interactions that act as supramolecular, physical cross-links within the TU segment.

When heating the material, the hydrogen bonds remain nearly unaffected up to 110° C., as indicated by the minor changes in the hydrogen-bonded and free stretching bands (FIG. 3c). However, at 120° C., the spectrum exhibits a sudden decrease in absorbance of the hydrogen-bonded amine and carbonyl stretching vibrations associated with the dissociation onset of the hydrogen bonds. Increasing the temperature further, the hydrogen-bonded carbonyl peak gradually decreases and shifts to higher wavenumbers until it fully disappeared at 200° C., accompanied by a gradual increase of the free carbonyl peak. The hydrogen-bonded amine vibration also decreased and shifted to higher wavenumbers. These findings apply to all PTUs and revealed three characteristic temperatures. At temperatures below 120° C., the hydrogen bonds are maintained, forming a physically cross-linked network ensuring mechanical stability of the material to preserve its shape and alignment upon thermal actuation. Contrarily, between 120° C. and 200° C., the hydrogen bonds are partly broken, allowing for strain-induced alignment of the LCEs that is fixed upon cooling owing to the thermo-reversibility of the hydrogen bonds. Furthermore, the physical cross-links are almost entirely absent at 200° C., ensuring melt-processable capabilities (vide infra).

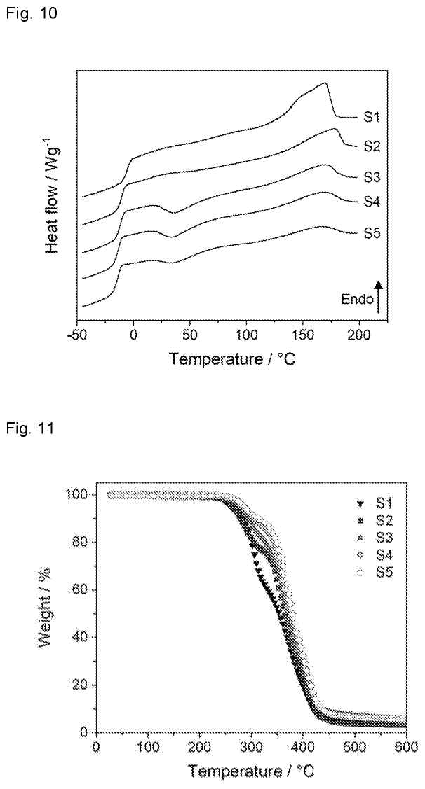

The thermal properties of the developed materials were assessed using differential scanning calorimetry (DSC) and thermogravimetric analysis (TGA). The DSC thermograms showed a transition ranging from −15 to −6° C. during heating, assigned to the glass transition temperature (Tg) of the LC segments (Table S4 and FIG. 10). The Tg shifts to lower temperatures when increasing the LC segment chain length from S1 to S5 due to decreased physical cross-link density and an increase in segmental mobility of the LC segment. Endothermic melting peaks (Tm) of the TU segment domains were observed at 164 to 177° C. Increasing the TU segment content from S5 to S1, the area under the Tms, and therefore the enthalpy of the transitions, increases as well. These results showed the existence of distinct LC and TU segments in the PTU LCEs. Furthermore, an exothermic peak is observed for LCEs S3 to S5 around 35° C., independent of the LC segment content. The TGA profiles revealed two transitions for all materials corresponding to the degradation of TU and ester moieties (FIG. 11). The thermoplastic LCEs exhibit a 1% weight loss around 245° C. due to the decomposition of the polymer, which is well above the processing temperatures indicating the desired thermal stability.

Dynamic mechanical analysis (DMA) was performed to characterize the dynamic viscoelastic properties of the thermoplastic PTU LCEs (Table S4). In the thermogram, storage modulus (E′) inflection points and loss tangent (tan δ) peak maximum were observed at around 10° C., corresponding to α-relaxation of the LC segment (FIG. 4a). Moreover, a shoulder was observed at approximately 40° C. for LCEs S3 to S5. The rubbery plateau was observed between 65 to 150° C. Upon increasing the LC segment length and decreasing the TU segment content from S1 to S5, the α-relaxation transition shifts to lower temperatures, and the magnitude of E′ at the rubbery plateau region decreases consistently. This decrease in temperature and rubbery modulus arises from the decreasing concentration of TU segment domains, which act as physical cross-links. The onset of the melting transition of crystalline TU segment domains is revealed by the distinct increase in tan δ and decrease in E′ at higher temperatures where the material enters the viscoelastic flow region. When increasing the temperature further, the materials show viscous flow, and the elastic properties are lost. The observed α-relaxation and melting temperature transition trends are consistent with the obtained Tg of the LC segment and Tm of the TU segment in DSC. Similar to the temperature-dependent FTIR measurements, it can be seen from the DMA temperature profiles of tan δ that the developed materials exhibit three distinct temperature regions. At the rubbery region, the tan δ is constant, indicating that the physical cross-links are maintained and the material acts as a covalently cross-linked system. In the viscoelastic flow region, the supramolecular network is partially broken allowing for strain induced orientation of the material upon stretching, whereas at higher temperatures it becomes melt processable due to the viscous flow.

Tensile tests were performed to study further the mechanical properties and the LC segment length effect (Table S5). From the stress-strain curve, it was observed that the Young's modulus decreased with increasing LC segment size from S1 to S5 (FIG. 4b), which is in line with the observed trend of the rubbery plateau in DMA. Moreover, the plateau region in the stress-strain curve becomes gradually longer at larger LC segment lengths. The elongation at break increases and the tensile strength decreases accordingly. These observations arise from the lower concentration of physical crosslinking points in the material due to the relative decrease of TU segment content. The observed plateau in the stress-strain curve is characteristic for LCEs at which the polydomain material is gradually oriented along the stretching direction, essential for the preparation of aligned LCEs with programmed alignment.

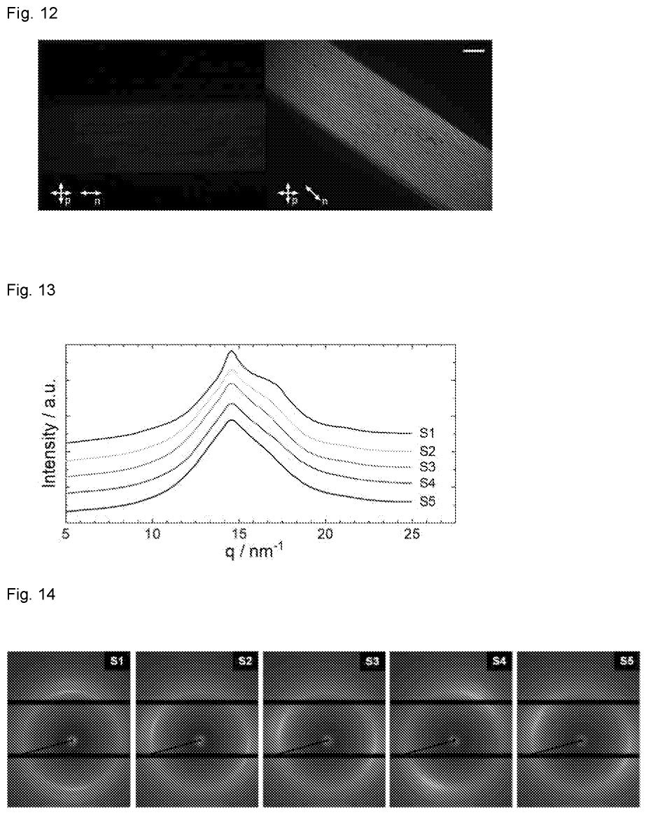

In order to demonstrate the reversible shape morphing behavior of the developed thermoplastic PTU LCEs, aligned actuators were prepared first (FIG. 1). Polydomain samples were obtained by compression molding the materials at 200° C., which is well above the melt transition and below the degradation temperatures. The compression-molded polydomain samples were uniaxially elongated (¿=100%) at room temperature and subsequently annealed at 130° C. for 30 min, where new physical cross-links were formed as this temperature is just above the onset of hydrogen-bond dissociation. Since the material is programmed at higher temperatures, at which the molecular order is reduced, the stretched thermoplastic LCEs spontaneously elongate when cooled to room temperature due to spontaneous organization of the LC segment into the ordered mesophase. After this process, the resulting oriented LCEs appear transparent (FIG. 1). In polarized optical microscopy (POM), the stretched material exhibited birefringence upon rotating the sample 45° between cross polarizers, indicating alignment (FIG. 12).

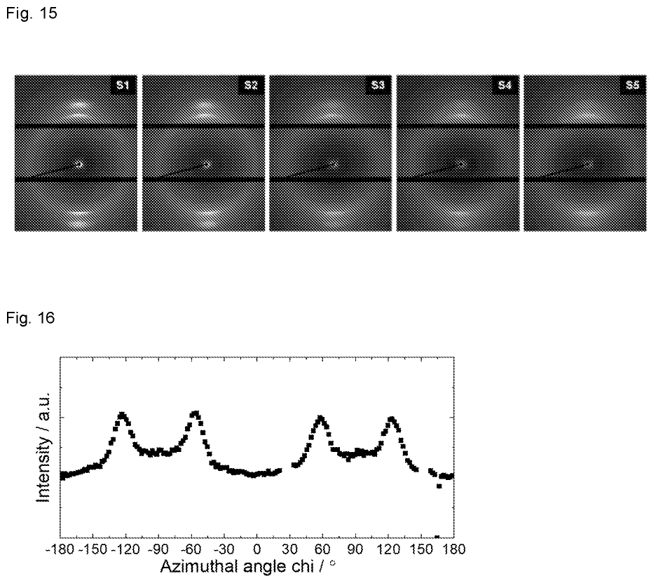

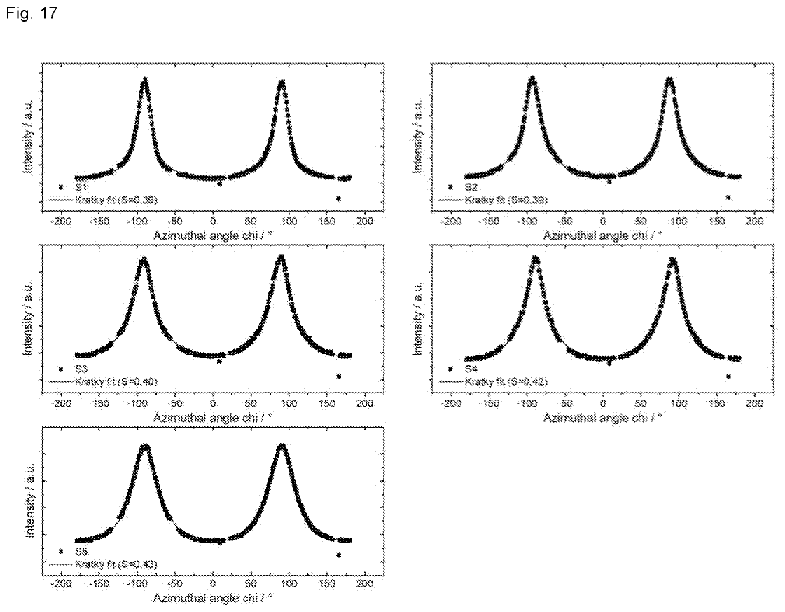

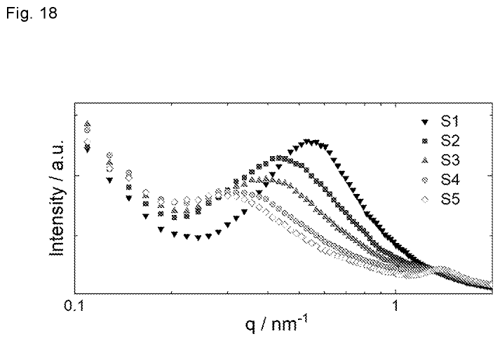

To verify the molecular orientation and segmental organization, the aligned PTU LCEs were studied with wide- and medium-angle X-ray scattering experiments (WAXS and MAXS). It is important to note that the oriented samples were measured without an externally applied load. In the wide-angle diffractograms, multiple diffraction peaks at q=10.2, 14.5, 17.2, and 21.3 nm-1 and an amorphous halo were observed due to the scattering of LC segment chains and TU segment moieties (FIG. 4c). The diffraction became weaker upon decreasing the TU segment content from 31 wt % (S1) to 10 wt % (S5). Therefore, it is conceivable that these peaks correspond to the scattering of TU moieties suggesting the formation of well-crystallized TU domains and increased crystallinity of the LCEs at higher TU segment content. The diffraction peaks at q=14.5 and 17.2 nm-1 correspond to d-spacings of 0.43 and 0.37 nm, respectively, which are assignable to the characteristic intermolecular spacings between the TU moieties in the hydrogen-bonding direction and orthogonally. Both the mesomorphic soft segment chains and TU hard segment moieties undergo strain-induced orientation upon stretching during the orientation process, as indicated by the stronger diffraction peaks in the diffraction profiles of aligned LCEs (FIG. 4c), compared to unaligned LCEs (FIG. 13). The 2D WAXS diffractograms of the initial polydomain samples showed ring-shaped, isotropic patterns suggesting the random orientation of the segmented domains (FIG. 4d; FIG. 14). In contrast, the wide-angle 2D X-ray diffraction patterns of the oriented LCEs showed typical orientationally arranged diffraction spots orthogonal to the elongation direction (FIG. 4e; FIG. 15). These patterns arise from the associated scattering of well-aligned LC and TU domains facilitated by the director alignment of oriented LCEs. The aligned samples also exhibit a four-point pattern at an azimuthal angle of 60° from the stretching direction (FIG. 16), attributed to the scattering of TU structures. It is believed that the TU moieties adopt a chevron-like geometry that is oriented along the orientation direction upon stretching, resulting in four-point scattering. The corresponding scattering peak was observed at q=10.2 nm-1 (d=0.62 nm) and reflected the characteristic length of TU moieties. The above observations show that the material is aligned during the orientation process yielding anisotropic LCEs. Moreover, the aligned LCEs show an order parameter between 0.39 and 0.43 with the same degree of stretching during the orientation process (FIG. 17). In contrast, unaligned samples exhibit a diffuse halo with a very low orientational order, likely induced by sample handling. It should be noted that the order parameter is measured of the whole material since the observed signals of the LC and TU segments were overlapping. In the small-angle region of the medium-angle diffractogram, a peak originating from the interdomain spacing is observed due to the formation of microphase-separated morphologies (FIG. 4f). With increasing LC segment length, the interdomain spacing of the microphase separated segments increases for elastomers S1 and S5 from 12.6 to 22.4 nm, respectively. On the other hand, the intensity of the signal is reduced as the relative amount of TU segment becomes less with increasing LC segment length. Comparing the MAXS diffraction profiles before and after aligning the LCE shows a similar interdomain spacing trend indicating that the microphase-separated morphology is unaffected upon forming oriented LCEs (FIG. 18). The apparent interdomain spacings indicate the formation of well-defined microphase-separated structures consisting of LC and hydrogen-bonding TU domains that act as reversible switching segments and supramolecular cross-links in the thermoplastic LCE, respectively.

Unbiased reversible shape change of the oriented thermoplastic LCEs was observed when heated and cooled between 30° C. and 110° C. showing a maximum actuation strain ratio of 32% (FIG. 5a, b). Upon heating above 130° C., the strain-induced orientation is erased, and the reversible actuation behavior is lost. Therefore, the LCEs are heated to a maximum temperature of 110° C., at which the extent of hydrogen bonding is maintained (vide supra). In the thermal cycling experiments, the LCE instantly contracted along with the programmed director field when heated and completely recovered to the initial length upon cooling. The magnitude of actuation strain increases significantly when increasing the LC segment length from LCE S1 to S5 due to the higher LC content and decreasing stiffness of the material. This indicates that the LC segment content dominates the thermal actuation behavior. To demonstrate the developed actuators' immediate reversible response and weightlifting capabilities, LCE S5 was repeatedly heated and cooled while loaded with various weights. The loaded actuator contracted rapidly when heated to approximately 80° C., which completely recovered to its initial length upon removing the heat source (FIG. 5c). Moreover, the thermoplastic LCE actuator loaded with 5 grams of weight exhibited fully reversible actuation over at least five heating and cooling actuation cycles, indicating the maintained orientation and thermal stability of the supramolecular cross-linked actuator (FIG. 5d; Video S1). As loading is increased from 5 to 30 grams, the actuation strain gradually decreased until, eventually, the sample hardly contracted (Video S2). The thermal actuation performance of oriented thermoplastic LCEs was further characterized when subjected to initial bias stress of 250 kPa as a function of temperature in the DMA (FIG. 5e). The observed actuation exhibits a similar trend and magnitude of actuation strain for all samples observed for unbiased actuation before. Additionally, the actuator's work capacity was calculated with a maximum energy density of 102 kJ m-3, corresponding to an actuation strain of 32% for LCE S5 (FIG. 5f).

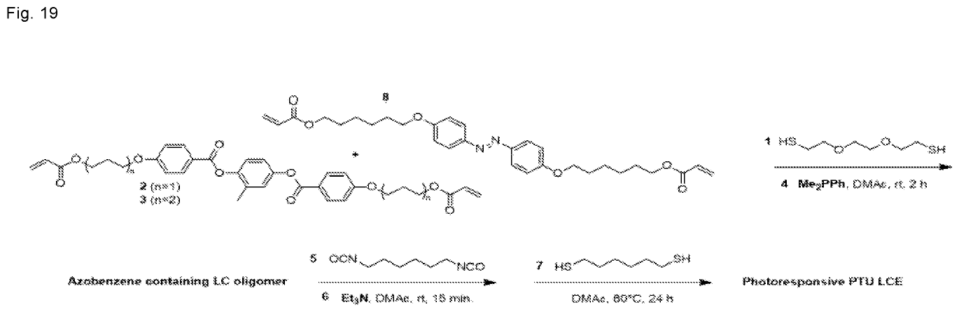

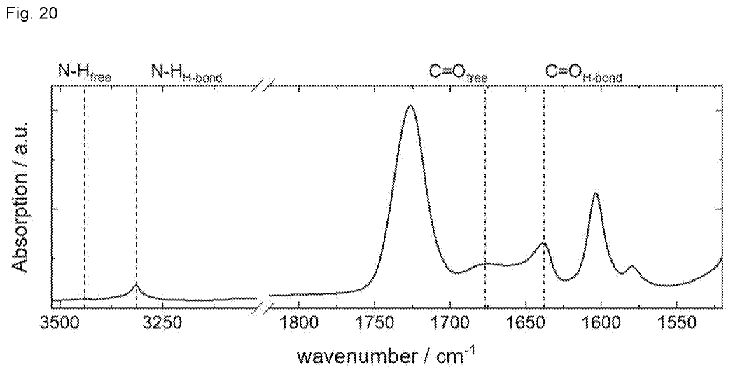

Light-driven actuation of the developed thermoplastic material is demonstrated through the incorporation of an azobenzene photoswitch, which is often used in conventional LC polymer actuators. Again, like the one-pot synthesis described before, a photoresponsive LCE is synthesized based on PTU S5 (Table S6) by simply adding azobenzene derivative 8 (3 mol %) along with the diacrylate mesogens (FIG. 19). Polymerization was confirmed by GPC and FTIR (Table S7 and FIG. 20),

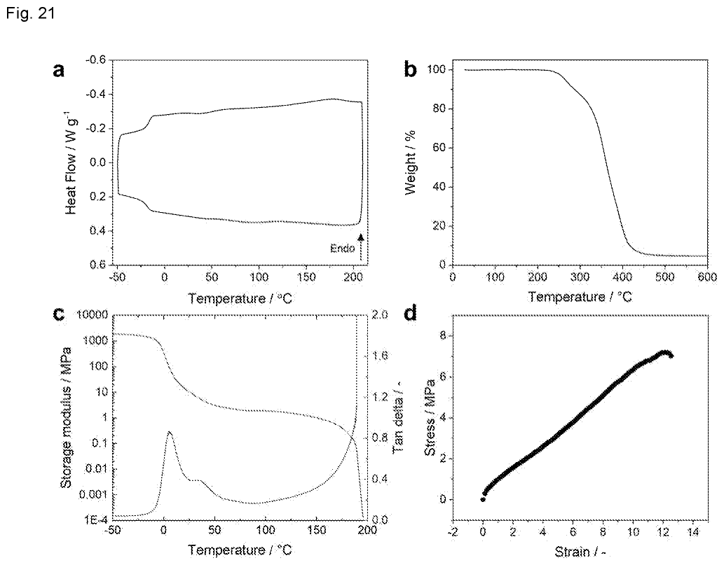

), whereas thermal and mechanical properties were characterized with DSC, TGA, DMA, and tensile testing (FIG. 21). The LCE film bends towards the light source upon illumination with UV light (365 nm) in air due to absorption of the azobenzene derivative (FIG. 6a, b; Video S3). The azobenzene derivative undergoes light-induced isomerization from its rod-like trans state to the bent cis isomer via the absorption of UV light (FIG. 6c). Accompanied with this trans-cis isomerization, the molecular order is disrupted due to conformational change of the isomer inducing anisotropic contraction and expansion along with the molecular director, thereby converting the absorbed light energy into mechanical work. Due to the relatively high azobenzene content, a cis-trans gradient is created throughout the film resulting in contraction of the exposed side leading to macroscopic bending. After removing the UV light, the film partially unbends and subsequently remains in a temporary stable state (FIG. 6a, b). This partial unbending motion is most likely the consequence of a photothermal effect; UV light absorption of the azobenzene chromophores results in photothermal heating and contraction of the film that reversibly expands into its temporary deformed state upon turning off the light. Photo-induced back isomerization of the trans azobenzene moieties can be immediately triggered by exposure to blue light (455 nm), resulting in mechanical relaxation and large unbending deformations. However, only after turning off the blue light the film completely unbends to its initial state. This behavior can also be related to the light absorption of the azobenzene chromophores when exposed to blue light resulting in photothermal heating of the film. Underwater actuation of the photoresponsive thermoplastic LCE demonstrates almost no light-induced heating of the actuator since the generated heat is immediately lost into its surroundings as indicated by the small unbending motions after removing both UV and blue light (FIG. 6b; Video S4). Additionally, the amplitude of deformation in water is smaller than in air since the same light intensities are used for both surroundings resulting in a higher intensity of incident light in air due to the light absorption of water. These observations demonstrate that both photomechanical and photothermal effects contribute to the light-driven actuation of the azobenzene containing PTU LCE, with the former being the main factor enabling light induced actuation both in air and water.

Finally, utilizing the hydrogen-bonding motives' dynamic character, the LCE material can be recycled, reprogrammed, and welded, illustrating the functional advantage of integrating physical cross-links. To demonstrate the recyclability, a pristine film of PTU LCE S5 was cut into small pieces and remolded up to two times (FIG. 7a). The reprocessed material exhibited similar mechanical properties with an increase in elongation at break and tensile strength as observed from the stress-strain curves (FIG. 7b). Upon heating and cooling, the pristine and recycled materials showed the same actuation behavior (FIG. 7c). By reprogramming the shape of an aligned actuator, the material can be reconfigured and actuated again, showing a different type of deformation. A twisted ribbon was obtained by fixing one end of the actuator while twisting the other before thermal programming (FIG. 7d; Video S5). The reprogrammed actuator contracts and untwists upon heating, accompanied by slightly bending of the sample. During cooling, the actuator regained its shape and conformation into its initial design. Additionally, it is shown that two programmed shapes can be welded together to form one single actuator. For example, the ends of a programmed strip and the twisted ribbon are welded together perpendicularly into a different geometry showing reversible temperature-triggered actuation (Video S6). The ease of reprogramming and welding allows for the fabrication of more complex shape designs and accompanying deformations.

We have successfully developed a new generation of melt-processable supramolecular cross-linked LCEs based on segmented PTU and demonstrated a processing method to obtain actuators by molding and stretching. The formation of well-defined TU domains affords supramolecular cross-links in the material through hydrogen bonding, providing the desired mechanical stability during actuation, whereas the reversibility of the hydrogen bonds allows for melt-processable materials with programmable molecular alignment. This approach is in line with typical processing methods for thermoplastic polymers using the polymer melt and allows for aligning the LCEs by enabling the processability of the network upon heating. When heated, the LCE actuators undergo reversible contraction capable of lifting a load. The material's properties can be systematically controlled by varying the LC segment length. Reversible light-driven actuation in both air and water is achieved by incorporating an azobenzene derivative. Reprocessing of an LCE film has been demonstrated, and reconfiguration of an actuator into another geometry exhibiting a different shape change upon applying an external stimulus was achieved through reprogramming and welding. We anticipate that these supramolecular cross-linked LCEs offer an innovative approach towards (re) programmable and recyclable stimuli-responsive materials. The properties of these LCEs can be easily further tuned and expanded by the reactive LC chemical toolbox that has previously been used to tune covalently cross-linked LC polymers.

### 4. Experimental Section

Materials: 1,4-Bis-[4-(3-acryloyloxypropyloxy)benzoyloxy]-2-methylbenzene (2) and 1,4-Bis-[4-(6-acryloyloxyhexyloxy)benzoyloxy]-2-methylbenzene (3) were obtained from Merck. Dimethylphenylphosphine (4, 99%) and N,N-Dimethylacetamide (DMAc, ≥99%) were purchased from Sigma-Aldrich. 2,2′-(Ethylenedioxy) diethanethiol (1, ≥97%), Hexamethylene diisocyanate (5, ≥98%), Triethylamine (6, ≥99%), and 1,6-Hexanedithiol (7, ≥97%) were purchased from Tokyo Chemical Industry (TCI). Diethyl ether (Et2O, ≥99.5%) was obtained from Biosolve. 4,4′-Bis(6-acryloyloxyhexyloxy) azobenzene (8, ≥95%) was obtained from Synthon. All reagents were used as received without further purification.

Synthetic procedure: A reaction vessel (100 mL) was charged with diacrylate mesogens 2 and 3 in DMAc (50 wt %) and allowed to stir under an inert atmosphere at 50° C. until fully dissolved. The solution was cooled to room temperature, and dithiol chain extender 1 was added while stirring, followed by nucleophilic catalyst 4 (0.1 wt %). The resulting reaction mixture was allowed to react at room temperature for 2 h. Afterward, diisocyanate 5 in DMAc (50 wt %) was added to the oligomer mixture immediately followed by base catalyst 6 (0.1 wt %) and allowed to stir at room temperature for 15 minutes. During this time, the mixture became viscous, and additional DMAc (30 wt %) was added to the prepolymer mixture. Next, dithiol 7 was added dropwise, and after complete addition, the reaction mixture was heated at 60° C. and allowed to react overnight. The crude mixture was poured into cold Et2O (500 mL) while stirring vigorously, and the polymer precipitated over time. The product was added to fresh Et2O (200 mL) and stirred overnight. The solvent was decanted, and the final polymer was dried at 40° C. under vacuum affording a white solid (≥97% recovery). The molar ratios and formulations for the synthesized thermoplastic PTU LCEs can be found in the Supporting Information (Table S1, S2). The photoresponsive PTU LCE was synthesized following the same synthetic procedure by adding the azobenzene derivative 8 along with diacrylate mesogens 2 and 3 in the first addition reaction step mesogens (Table S6 and FIG. 19).

Characterization: FTIR spectra were recorded on a Varian 670 IR spectrometer equipped with an attenuated total reflectance (ATR) sampling accessory using a diamond crystal over a range of 4000-650 cm-1 with 50 scans per spectrum and a spectral resolution of 4 cm-1. All spectra were recorded at room temperature unless stated otherwise. The obtained spectrums are processed with Varian Resolutions. Gel permeation chromatography (GPC) was performed on a Waters HPLC system equipped with a PSS PFG (8×50 mm, 7 μm) and two PFG linear XL columns (8×300 mm, 7 μm) in series. 1,1,3,3,3-hexafluoro-2-propanol (HFIP) with potassium trifluoroacetate (20 mm) at 35° C. was used as mobile phase supplied at a flow rate of 0.8 mL min-1. The samples were prepared in HFIP with potassium trifluoroacetate (20 mM) and toluene (20 mm) at room temperature. The molecular weights were determined using a refractive index detector relative to poly(methyl methacrylate) standards. DSC measurements were performed using a TA Instruments Q1000 DSC instrument with hermetic T-zero aluminum sample pans. All scans were conducted with 10±1 mg polymer over a temperature range from −50 to 200° C. at heating and cooling rates of 10° C. min-1 under nitrogen atmosphere. The second heating and cooling cycles were used to determine the enthalpies and transition temperatures of all samples. TGA was carried out on a TA instruments Q50 instrument with 4±0.5 mg polymer over a temperature range from 28 to 800° C. and a heating rate of 5° C. min-1. DMA was performed on 8×5.3×0.4 mm3 (L×W×T) samples cut from compression-molded films with a TA Instruments Q800 apparatus in vertical tension mode. The thermographs were measured from −50 to 250° C. with a heating rate of 5° C. min-1, a single 1 Hz oscillating frequency, 10 μm amplitude, and 0.01 N preload force. Stress-strain curves were obtained with a Lloyd-Ametek EZ20 tensile testing machine using a 500 N load cell. The strain is defined as (I-L)/L where L is the initial length, and I is the length at a particular time. Dog-bone specimens with a cross-sectional area of 2×0.4 mm2 (W×T) were cut from compression-molded films and uniaxially elongated at an elongation rate of 10 mm min-1 with a gauge length of 20 mm until failure. X-ray scattering measurements were performed on a Ganesha lab instrument equipped with a Genix-Cu ultralow divergence source that generates X-ray photons with a wavelength and flux of 0.154 nm and 1×108 photons s-1, respectively. Diffraction patterns were obtained using a Pilatus 300 K silicon pixel detector with 487×619 pixels of 172×172 μm2. Silver behenate was used as a calibration standard. The sample-to-detector distance was 89 mm for wide-angle (WAXS) configurations, whereas, for medium-angle (MAXS), the detector was operated at 439.5 mm. The collected data were reduced and analyzed using a custom Python script with the PyFAI software package. D-spacings were calculated using the equation d=2π/q. The orientational order parameters were calculated from the diffraction patterns using the Kratky method. POM was carried out with a Leica DM2700 M microscope and crossed polarizers.

Fabrication procedures: First, the polymer was dried at 60° C. for at least 1 h before processing. Then, the material was loaded homogenously into a 20×40×0.1 mm3 (L×W×T) mold and covered with polytetrafluoroethylene (PTFE) protection sheets (T=0.12 mm) on both sides. The mold was heated to 200° C. in a Collin P200E press and subjected to five breath cycles with a mold pressure of 50 bar. The final compression molding process was performed at 100 bar and 200° C. for 2 min, whereafter the mold was immediately quenched to room temperature to form polydomain polymer films. Dog-bone shaped specimens with dimensions of 35×2×0.4 mm3 (L×W×T) were cut from compression-molded polymer films and uniaxially strained at room temperature by using a custom-made stretching instrument until elongation reached 100%. The strained samples were then heated to 130° C. for 30 minutes and subsequently cooled to room temperature while remaining strained. It was noticed that during cooling, the aligned samples spontaneously elongated above the initially applied strain. Finally, the aligned LCEs were annealed at room temperature for 48 h before characterization and testing. For recycling, a film was cut into small pieces and compression-molded according to the previously described procedure. The twisted ribbon actuator was obtained by twisting one end of an aligned LCE while fixing the other and subsequently heating it to 130° C. for 30 minutes after which it was cooled to room temperature. Welding was performed by overlapping the end of two actuators and heating it to 200° C. for 2 minutes.

Actuation measurements: Thermal actuation measurements were performed by placing aligned samples on a black anodized aluminum sheet on top of a hotplate. The samples were heated from 30 to 110° C. by gradually increasing the temperature in intervals of 10° C. Afterward, the samples were allowed to cool to room temperature. All samples were subjected to a full heating and cooling cycle to erase the thermal history before the actuation measurement. Photographs were taken at each temperature using a camera (Olympus OM-D E-M10 Mark III), and the obtained images were analyzed using ImageJ. Weightlifting tests were conducted with various weights attached to the sample with a paper clamp (1.26 g) and heated to around 80° C. using a heat gun. Actuation strain was measured on a TA Instruments Q800 DMA by monitoring the sample length as a function of temperature. Samples with dimensions of 8×1.3×0.3 mm (L×W×T) were measured in controlled force mode from −50 to 120° C. at a heating rate of 5° C. min-1 under initial bias stress of 250 kPa (constant force). All samples were heated to 110° C. for 3 minutes before the measurement to ensure the thermal history was erased. The corresponding work capacity was calculated from Equation 1, considering that the bias stress depends on the cross-sectional area of the samples, which changes upon actuation.

$$Work capacity = W / V = F\_bias Δ L / LWT = F\_bias / WT \cdot Δ L / L = σ\_bias ε\_bias [ kJ {m}^{⋀} ( - 3 ) ] \qquad ( 1 )$$

Light-driven actuation was performed by hanging the aligned film with dimensions of 19.11×1.52×0.23 mm (L×W×T) at around 10 cm distance from the collimated light sources with light emitting at 365 nm (UV light, Thorlabs M365L2) or 455 nm (Blue light, Thorlabs M455L3-C2). The light intensity of the LEDs was controlled using a LED driver (Thorlabs DC4104). Photoactuation in air was performed at room temperature with intensities of UV and blue light set to 25.2 mW cm-2 and 34.5 mW cm-2, respectively. For underwater photoacutation, the sample was submerged in a transparent container with tap water at room temperature and illuminated with UV and blue light with intensities of 20.1 mW cm-2 and 28.5 mW cm-2, respectively. The light-driven actuation was recorded using a camera (vide supra).

FIG. 1. Preparation of supramolecular cross-linked LCE actuators based on a thermoplastic PTU as melt-processable material. One-pot polymerization of the monomers gives a segmented block copolymer and compression molding the obtained material yields polydomain films. Subsequent programming by elongating the material at elevated temperatures allows for a uniform director field (n).

FIG. 2. The synthesis of segmented PTU LCEs S1-S5 using sequential addition reactions and the corresponding composition, Sx. The blue rectangles and grey rods represent the TU and LC segments, respectively.

FIG. 3. a) Molecular representation of hydrogen-bonded TU segments in the segmented polythiourethane LCEs. b) FTIR spectra of the PTU LCEs S1-S5 showing free and hydrogen-bonded TU amine and carbonyl stretching band regions as indicated by the dashed lines. c) Temperature-dependent FTIR spectra of compression-molded PTU LCE S1. The black arrows indicate the increase and decrease of the vibrations upon heating. FIG. 4. a) DMA storage modulus (E) and loss tangent (tan δ) profiles as a function of temperature of the compression-molded PTUs S1-S5. The black arrows denote the corresponding axis. b) Stress-strain curves at room temperature of the compression-molded PTUs S1-S5. c) 1D WAXS diffractograms of the aligned PTUs S1-S5. 2D WAXS diffractograms of PTU S1 d) before and e) after programming. The white arrow denotes the alignment direction. f) 1D MAXS diffractograms of the aligned PTUs S1-S5.

FIG. 5. a) Images of the LCE actuators S1-S5 (from left to right) at 30° C. and 110° C. b) The corresponding actuation strain as a function of temperature. c) Images of PTU LCE S5 lifting an additional weight (5 g) when heated to 80° C. d) Actuation strain upon cycling the PTU LCE S5 with a load (5 g) between room temperature and 80° C. The red and blue boxes correspond to the heating and cooling of the actuator, respectively. e) Thermal actuation of the aligned LCEs S1-S5 under constant bias stress (250 kPa). f) Maximum actuation strain ratio and corresponding actuation work capacity for each LCE.

FIG. 6. a) Images of the actuation in air: (i) actuator at room temperature before illumination; (ii) UV light (25.2 mW cm 2) induced bending motion; (iii) temporary stable state of the actuator after removal of UV irradiation; (iv) blue light (34.5 mW cm 2) induced unbending motion; (v) complete unbending to the initial state upon turning off the blue light. The actuator is illuminated from the left resulting in bending towards the light source. b) Tip displacement of the actuator as a function of time in both air and water during UV (violet) and blue (blue) light illumination. The numbered regions correspond to the images in a). c) Light-induced trans-cis isomerization of an azobenzene derivative and schematic representation of the reversible light-driven bending motion arising from geometrical changes of the azobenzene moiety in response to light. The grey and orange rods represent the LC and light-responsive azobenzene moieties, respectively. Exposure to UV light leads to a light absorption (i.e., cis-trans) gradient in the film indicated by the darker orange color.

FIG. 7. a) Reprocessing cycle of PTU LCE S5 illustrating cutting and remolding of the film. b) Stress-strain curves at room temperature and c) the actuation strain as a function of temperature of pristine and remolded samples. d) Reprogramming of aligned LCE S5 into a twisted ribbon and the corresponding actuation in response temperature.

TABLE S1
Molar ratio of the monomers used for the synthesis
of the thermoplastic PTU LCEs S1-S5.

| PTU | (1) | (2) | (3) | (5) | (7) |
|---|---|---|---|---|---|
| S1 | 4 | 1 | 1 | 2 | 1 |
| S2 | 3 | 1 | 1 | 2 | 1 |
| S3 | 2.67 | 1 | 1 | 2 | 1 |
| S4 | 2.50 | 1 | 1 | 2 | 1 |
| S5 | 2.40 | 1 | 1 | 2 | 1 |

TABLE S2
Formulation of the thermoplastic PTU LCEs S1-S5. Number of
repeating units (n) for LC segment and TU segment length as
obtained by theoretical calculation using Carothers' equation.
Corresponding theoretical number average molecular weight
(M_{n,theo}) and content of the LC segment and TU segment.

| | LC segment | | | TU segment | | |
|---|---|---|---|---|---|---|
| | | M_{n,theo} | | | M_{n,theo} | |
| PTU | n | [g mol⁻¹] | wt % | n | [g mol⁻¹] | wt % |
| S1 | 1 | 995 | 67 | 1 | 487 | 33 |
| S2 | 2 | 1808 | 79 | 1 | 487 | 21 |
| S3 | 3 | 2621 | 84 | 1 | 487 | 16 |
| S4 | 4 | 3434 | 88 | 1 | 487 | 12 |
| S5 | 5 | 4247 | 90 | 1 | 487 | 10 |

TABLE S3
GPC results of the thermoplastic PTU LCEs S1-S5.

| PTU | M_{n, GPC} [g mol⁻¹] | PDI |
|---|---|---|
| S1 | 157430 | 2.66 |
| S2 | 150385 | 2.41 |
| S3 | 139576 | 2.28 |
| S4 | 95973 | 2.18 |
| S5 | 84837 | 1.96 |

FIG. 8. FTIT Spectra of poludomain PTU LCEs s1-s5.

FIG. 9. C═O_{H-bond}/C═O_{free} ratio as a function of hard segment content.

TABLE S4
The DSC and DMA results of the thermoplastic
PTU LCEs S1-S5.

| | DSC | | | | DMA | | |
|---|---|---|---|---|---|---|---|
| | T_{g} | Tₑₓₒ | Tₘ | ΔH_{f} | T_{g} | Tₘ | E′ |
| PTU | [° C.] | [° C.] | [° C.] | [J g⁻¹] | [° C] | [° C.] | [MPa] |
| S1 | −6.3 | — | 169.4 | 20.8 | 22.9 | 165.2 | 22.73 |
| S2 | −11.2 | — | 176.8 | 12.0 | 15.7 | 167.8 | 10.0 |
| S3 | −12.3 | 36.9 | 167.9 | 10.7 | 12.0 | 158.0 | 6.5 |
| S4 | −14.3 | 35.1 | 166.8 | 9.0 | 11.7 | 156.9 | 3.2 |
| S5 | −14.7 | 36.2 | 164.6 | 6.9 | 3.5 | 137.5 | 2.8 |

FIG. 10. DSC thermographs of the PTU LCEs S1-S5. The second heating run is shown.

FIG. 11. Thermogravimetric profiles of PTU LCEs S1-S5.

TABLE S5
Summary of mechanical properties of
the thermoplastic PTU LCEs S1-S5.

| | Young's modulus | Tensile strength | |
|---|---|---|---|
| PTU | [MPa] | [MPa] | Elongation at break |
| S1 | 67.4 | 44.8 | 4.3 |
| S2 | 25.1 | 24.5 | 5.2 |
| S3 | 14.7 | 21.0 | 5.6 |
| S4 | 6.7 | 13.5 | 5.9 |
| S5 | 3.9 | 9.3 | 9.7 |

FIG. 12. POM images of programmed PTU LCE S5 under cross polarizers. The crossed arrows indicate the polarizer directions (p), and the single arrow the molecular director of the aligned material (n). The scale bar is 200 μm.

FIG. 13. 1D WAXS diffractograms of polydomain PTU LCEs S1-S5.

FIG. 14. 2D WAXS diffractograms of polydomain PTU LCEs S1-S5. The observed orientation is attributed to the sample preparation and handling.

FIG. 15. 2D WAXS diffractograms of programmed PTU LCEs S1-S5. The molecular director of the aligned materials is horizontal.

FIG. 16. Azimuthal profile of 2D WAXS diffractograms at q=1.00-1.05 nm-1 for PTU LCE S1.

FIG. 17. Azimuthal profiles of 2D WAXS patterns at q=1.43-1.46 nm-1 for PTU LCEs S1-S5. The order parameter was obtained by fitting a Kratky function over the azimuthal angle by a custom-made script.

FIG. 18. 1D MAXS diffractograms of polydomain PTU LCEs S1-S5. An additional peak is observed at q=1.37 nm₋₁ originating from the spacing between the mesogens within the soft segment (d=4.6 nm). For samples with larger LC segment lengths, the signal is stronger.

TABLE S6
Molar ratio of the monomers used for the synthesis
of the photoresponsive thermoplastic PTU LCE.

| Monomer | (1) | (2) | (3) | (5) | (7) | (8) |
|---|---|---|---|---|---|---|
| Molar ratio | 2.40 | 0.9175 | 0.9175 | 2 | 1 | 0.165 |

FIG. 19. Synthesis pathway of the photoresponsive PTU LCE.

TABLE S7
GPC results of the photoresponsive PTU LCE.

| M_{n, GPC} [g mol⁻¹] | PDI |
|---|---|
| 56357 | 1.78 |

FIG. 20. FTIR spectra of polydomain photoresponsive PTU LCE.

FIG. 21. a) DSC thermograph, b) TGA profile, c) DMA, and d) stress-strain curve of the photoresponsive PTU LCE.

1. A method for the preparation of a thermoplastic liquid crystalline polymer, the method comprising the following steps:
a) reacting a di(meth)acrylic mesogenic monomer and a bifunctional thiol or amine component for preparing a mesogenic bifunctional polymer, and
b) reacting the mesogenic bifunctional polymer of a), a bisacrylamide, isocyanate or bismaleimide, and a bifunctional thiol, alcohol or amine component for preparing the thermoplastic liquid crystalline polymer.

2. A method according to claim 1, wherein in step a) a mesogenic bifunctional polymer, represented by general formula (1), is prepared by reacting at least a liquid crystalline bisacrylate or bismethacrylate component (X), and a bifunctional thiol or amine component (L₁-Z₁), and where in step (b) a copolymer, represented by general formula (2), is prepared by reacting the mesogenic bifunctional polymer (1) of step (a), a bisacrylamide, isocyanate or bismaleimide (Y), and a bifunctional thiol, alcohol or amine component (L₂-Z₂).

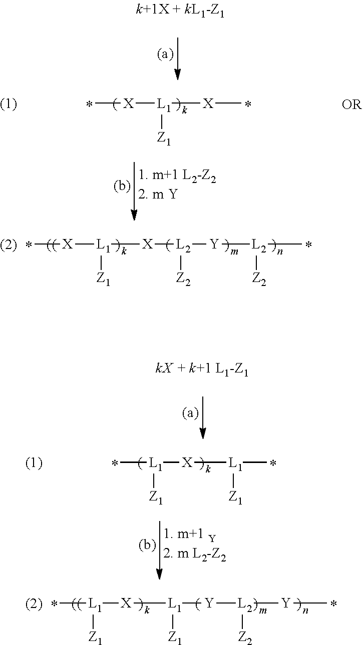

3. A method according to claim 2, wherein X is a mesogenic monomer containing at least two vinylic, two acrylic, or two methacrylic, or a combination of two of the aforementioned groups.

4. A method according to claim 3, wherein X is chosen from the group of:

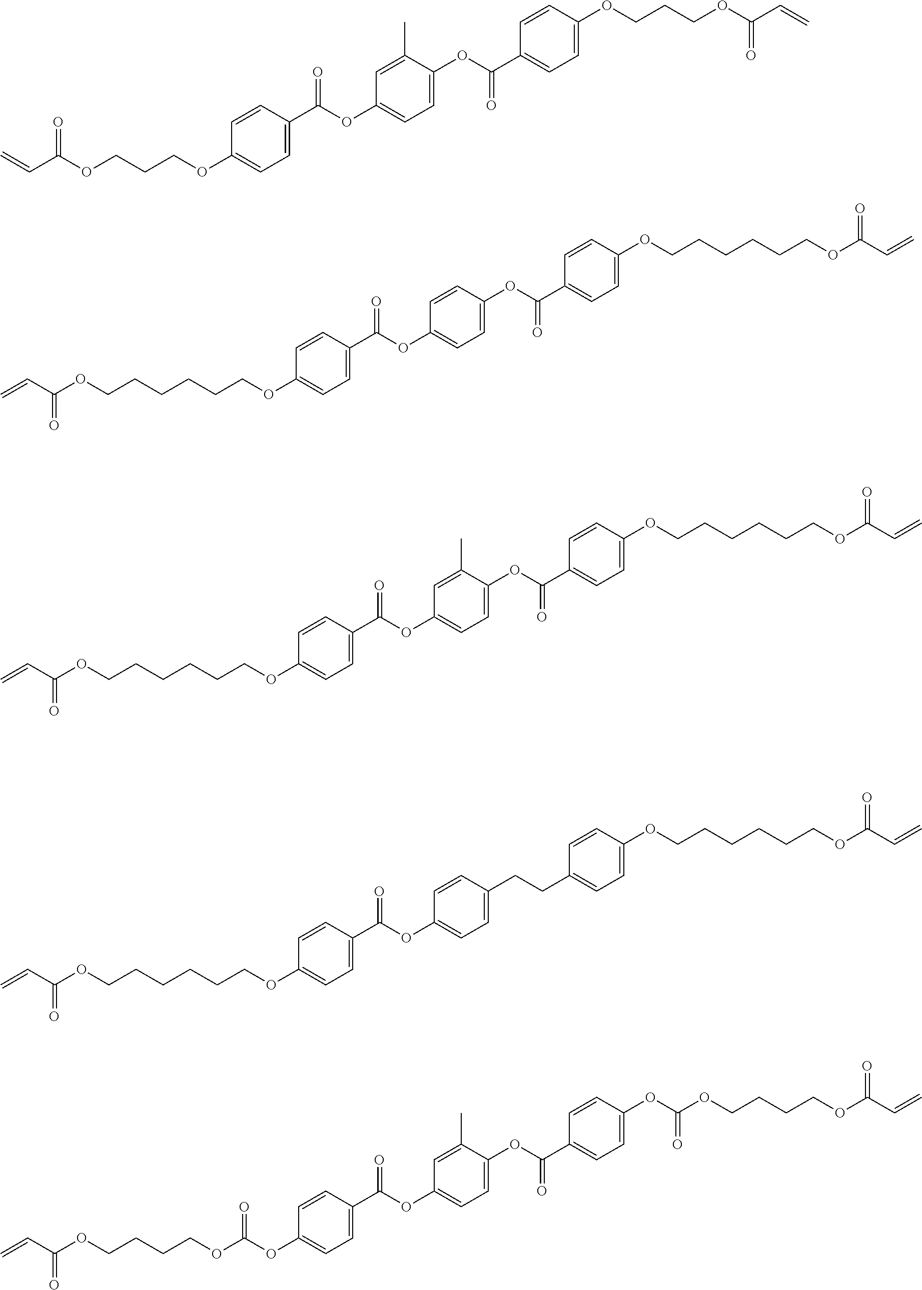

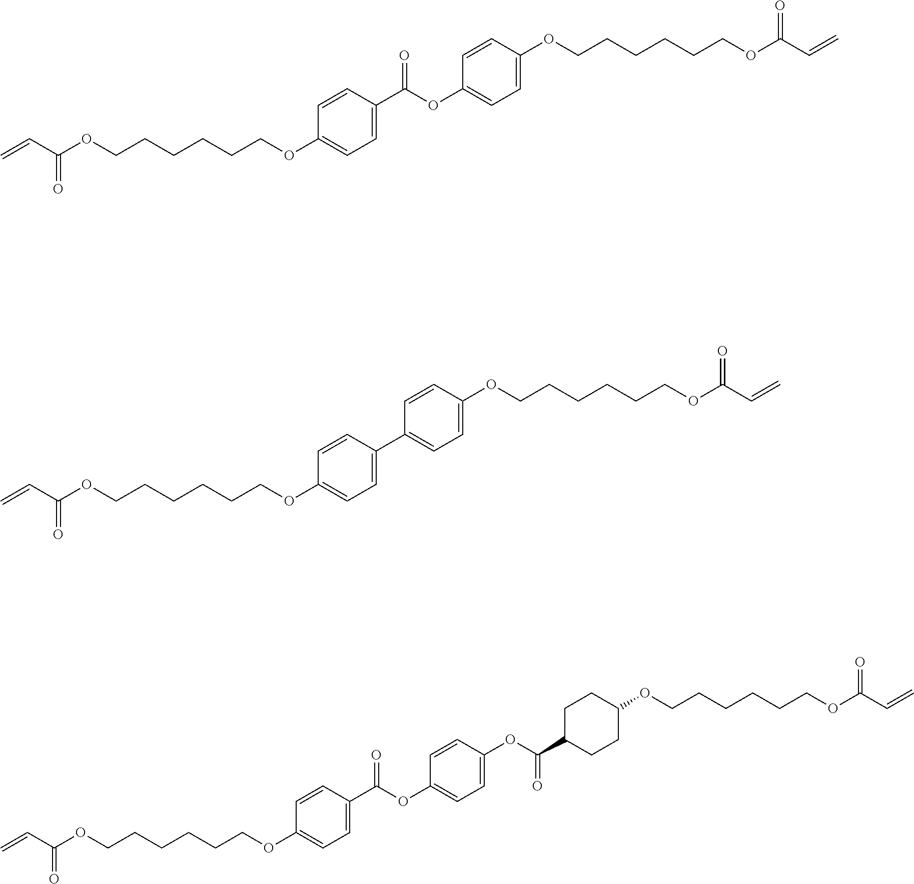

5. A method according to claim 2, wherein L1 and L2 are linking monomers, and Z1 and Z2 are side group on linking monomers, respectively.

6. A method according to claim 5, wherein L1, L2, Z1 and Z2 are chosen from the group of.

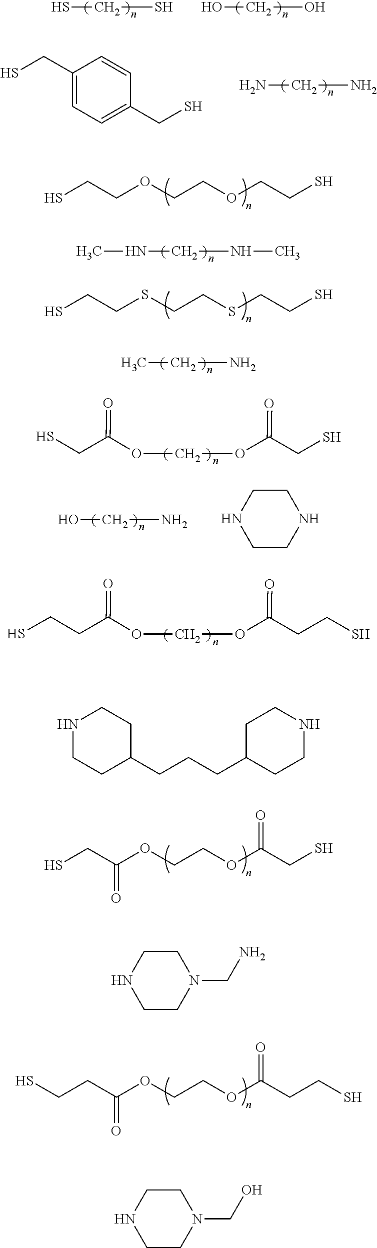

7. A method according to claim 2, wherein Y is a monomer chosen from the group of:

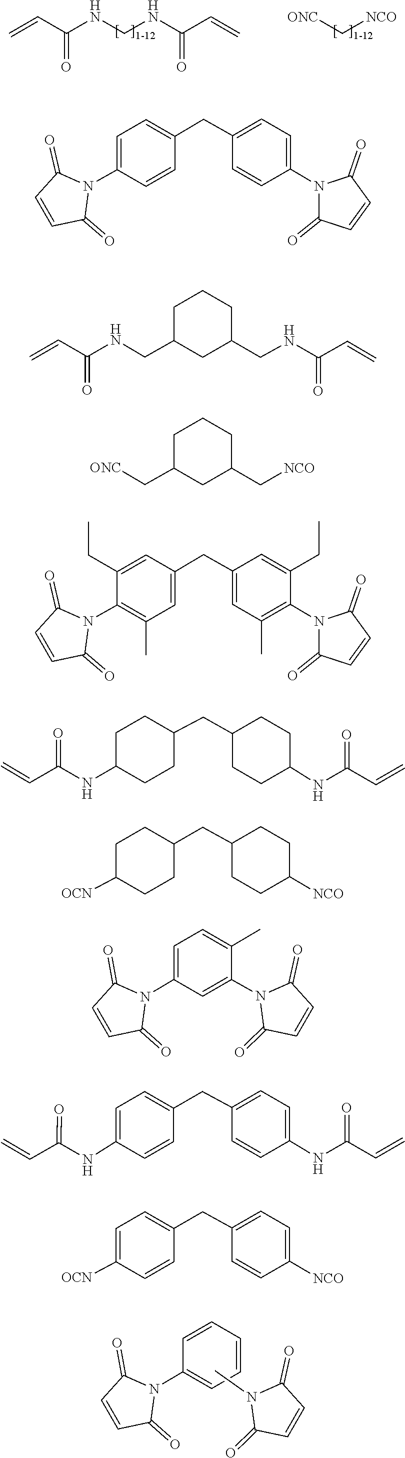

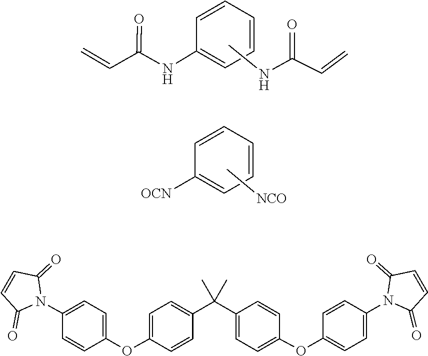

8. Segmented copolymers containing thiourethane, amide, or linear bismaleimide hard segments and liquid crystal soft blocks according to the following formula: 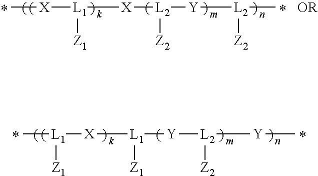
wherein:
X is a liquid crystalline bisacrylate or bismethacrylate component,
(L₁-Z₁) is a bifunctional thiol or amine component,
(Y) is a bisacrylamide, isocyanate, or bismaleimide,
(L₂-Z₂) is a bifunctional thiol, alcohol or amine component,
k is the average number of repeating units in the liquid crystalline soft segment,
m is the average number of repeating units in the hard segment,
n is the average number of repeating units in the polymer.

9. Segmented copolymers according to claim 8 exhibiting a T_{g} between −100° C. and Tₘ, and below the isotropization temperature (Tᵢ) of the mesogenic segment within the segmented copolymer.

10. Segmented copolymers according to claim 8 exhibiting a melting point (Tₘ, LC) of the mesogenic segment between T_{g} and Tₘ.

11. Thermoplastic liquid crystal elastomer (LCE) actuators comprising segmented copolymers according to claim 8.

12. Preparation of thermoplastic liquid crystal elastomer (LCE) actuators according to claim 11 through melt-processing and thermal programming.
